(19) United States
(12) Patent Application Publication
(10) Pub. No.: US 2017/0006889 A1
(43) Pub. Date: Jan. 12, 2017

(54) ACIDIC LACTIC BEVERAGE AND METHOD FOR PRODUCING SAME

(71) Applicants: ASAHI SOFT DRINKS CO., LTD., Tokyo (JP); ASAHI GROUP HOLDINGS, LTD., Tokyo (JP)

(72) Inventors: Yuka ISHIMORI, Sagamihara-shi (JP); Tetsuo KOIZUMI, Sagamihara-shi (JP)

(73) Assignees: ASAHI SOFT DRINKS CO., LTD., Tokyo (JP); ASAHI GROUP HOLDINGS, LTD., Tokyo (JP)

(21) Appl. No.: 15/113,534

(22) PCT Filed: Dec. 25, 2014
(86) PCT No.: PCT/JP2014/084406

§ 371 Date: Jul. 22, 2016

(30) Foreign Application Priority Data
Jan. 23, 2014 (JP) 2014-010742

(51) Int. Cl. A23C 9/154; A23L 2/68; A23L 2/60; A23L 2/66

(52) U.S. Cl. CPC A23C 9/1542; A23L 2/66; A23L 2/68; A23L 2/60; A23V 2002/00

(57) ABSTRACT

Provided is a thirst-quencher-like acidic milk-based beverage and a method for producing the same, of which white turbidity typical of milk-based beverages is suppressed, which provide milkiness characteristic of milk-based beverages, and which has the appearance desired of sports drinks. The acidic milk-based beverage contains milk, a stabilizer of milk protein, and water, and the solid non-fat content thereof is 0.15 to 0.4 mass %, and the pH is not higher than 4.0. In particular, by controlling the lightness L to 25 to 47 in the Hunter Lab color space, the beverage made be useful as a thirst quencher beverage.

### FIELD OF ART

The present invention relates to acidic milk-based beverages that have good milkiness characteristic of milk-based beverages, as well as such high thirst-quenchability as to quench thirst like sports drinks and gulpability, and also to thirst-quencher-like acidic milk-based beverages that also have appearance desired of sports drinks, as well as to a method for producing the same and a method for improving thirst quenchability and milkiness of an acidic milk-based beverage.

### BACKGROUND ART

Acidic milk-based beverages have established a large market in today's refreshing beverage industry for their unique taste and flavor and due to consumers' trend toward naturalness and healthiness. These unique taste and flavor are said to be refreshingness due to sourness; sweetness; and richness and unique “umami” originated from the milk components (Non-patent Publication 1).

In recent years, due to diversification of consumer preferences, a variety of acidic milk-based beverages are demanded, such as those of low calorie content, those containing components that contribute to maintenance of good health, such as fruit or vegetable juice, or those of a high solid non-fat content.

Casein, which accounts for 80 to 85% of milk proteins, is said to take a micellar structure, in which submicelles are bound to each other, even in the neutral range, such as in milk. The micelles are most prone to sedimentation near pH 4.6, but also in the range of pH 3.0 to 4.2, where milk-containing acidic beverages develop their unique sourness, the micelles tend to associate with each other to form suspended particles of milk protein, which facilitates coagulation and sedimentation. In milk-containing acidic beverages of low calorie type, since use of sugar, which has a protein-protective effect, is limited, coagulation and sedimentation of suspended particles of milk protein are often problematic. The coagulation and sedimentation of milk proteins cause no health problems, but impair the aesthetic appearance of products and are in practice claimed by consumers.

As a stabilizer for use in the production of milk-containing acidic beverage of low viscosity without paste-like mouth feel, soybean dietary fibers are recently used. However, the soybean dietary fibers, of which taste and flavor per se affect the resulting products when used in a large amount, cannot be contained in a large amount. Further, considering the quantitative balance between the soybean dietary fibers and milk protein, a larger amount of milk protein may disturb the desired stabilizing effect of the soybean dietary fibers.

In view of the above problems, various proposals have been made to suppress coagulation and sedimentation of suspended particles of milk protein in milk-containing acidic beverages. For example, there have been proposed a method for producing acidic protein foods through simultaneous addition of water-soluble soybean polysaccharides and pectin (Patent Publication 1), a method for producing acidic milk beverages by fermenting dairy products with lactic acid bacteria in the presence of water-soluble hemicellulose derived from soybean (Patent Publication 2), and a method for producing dairy products by lactic fermentation of dairy products in the presence of a stabilizer, such as high methoxyl pectin (Patent Publication 3). Further proposed is a method for producing an acidic milk beverage having the average fermented sour milk particle size of 0.5 to 1.2 μm, including dissolving a stabilizer, such as pectin, and sugars, adding and dissolving milk components therein, and adding an acidic substance thereto to adjust the pH to a predetermined acidic range, to thereby make 95% of the fermented sour milk particles in the final product fall in the range of 0.1 to 6 μm.

As lactic acid bacteria beverage having refreshingness typical of thirst quencher beverages, there is proposed a lactic acid bacteria beverage containing lactic acid bacteria and solid non-fat, wherein the ratio (A/B) of the cell count A (cells/100 g) of the lactic acid bacteria to the solid non-fat content B (mass %) of the lactic acid bacteriabeverageis5.0×10⁹ to1.0×10¹², and which beverage contains galactomannans (Patent Publication 5). The publication reports that this lactic acid beverage has the refreshingness typical of thirst quencher beverages, the taste and flavor of the lactic acid bacteria beverage is improved, and odd taste and abnormal odor derived from lactic acid bacteria are suppressed (Patent Publication 5).

There is also proposed a method for producing an acidic milk-based beverage containing sulfate in an amount sufficient for maintaining, in the presence of sugar, the white turbidity at not lower than 35 in terms of lightness (L) as measured with a colorimeter, in the acidic range of pH 3.50 or lower, in order to stably maintain the white turbidity that is favorable of milk beverages (Patent Publication 6).

Patent Publication 1: JP-2834345-B

Patent Publication 2: JP-H07-59512-A

Patent Publication 3: JP-H06-327402-A

Patent Publication 4: JP-2510435-B

Patent Publication 5: JP-2013-94154-A

Patent Publication 6: JP-S50-16422-B

Non-patent Publication 1: “Soft Drinks” (1989), Korin-sha, p 14

### SUMMARY OF THE INVENTION

### Problems to be Solved by the Invention

In recent years, thirst quencher beverages of various categories, such as sports drinks, are on the market. Among these, beverages containing minerals are popular in summer as measures against heat stroke.

On the other hand, generally, milk-based beverages mostly pursue palatability or substantiality in taste, and only a few are as highly thirst quenching as sports drinks. Thus, development is desired of new beverages that retain the mild taste and flavor and milkiness derived from milk, while gulpability and thirst-quenchability comparable to sports drinks are imparted.

Functionalities usually desired of thirst quencher beverages are “thirst quenchability”, “gulpability”, and the like. On the other hand, milk-based beverages are preference beverages that have “mildness” and “milkiness”. It has been hard to produce beverages having the above-mentioned functionalities of thirst quencher beverages without impairing the milkiness characteristic of milk-based beverages. For the purpose of producing such beverages, it is necessary, for example, to reduce the heaviness of milk-based beverages derived from solid non-fat, while enhancing the refreshingness typical of thirst quencher beverages that quench thirst. However, reduction of the solid non-fat content gives rise to a problem of impairment of the mild taste and flavor, which are otherwise characteristic attraction of milk-based beverages.

The low thirst quenchability of milk-based beverages may partly be attributed to their white appearance, but reduction of the solid non-fat content and the resulting lowering of the white turbidity for the purpose of enhancing thirst quenchability may cause the following problems.

Reduction of the milk components for enhancing the thirst quenchability results in loss of whiteness typical of milk-based beverages.

Casein contained in the milk components, coagulates and sediments when under an acidic conditions of lower than pH 4.6 for a prolonged period of time, and is thus prone to syneresis and becomes unstable. In view of this, in order to prevent coagulation and sedimentation of milk, addition of a stabilizer, such as polysaccharide thickeners, is indispensable to acidic milk-based beverages. However, reduction of the milk components for enhancing the thirst quenchability to thereby lower the white turbidity results in development of yellowish color tone originated from stabilizers, and the whiteness characteristic of milk-based beverages is impaired. On the other hand, too much reduction in the amount of stabilizers causes coagulation and sedimentation of milk as discussed above, which impedes maintenance of stability. Thus, good appearance and the milk protein stability should be balanced when the white turbidity is lowered.

It is an object of the present invention to provide acidic milk-based beverages which are capable of providing good milkiness characteristic of milk-based beverages, gulpable like sports drinks, and excellent in thirst quenchability.

It is another object of the present invention to provide thirst-quencher-like acidic milk-based beverages and a method for producing the same, of which white turbidity, typical of milk-based beverages, is suppressed, which provide good milkiness characteristic of milk-based beverages, and which have the appearance desired of sports drinks.

It is still another object of the present invention to provide acidic milk-based beverages that solve the above-mentioned problems and are also of low calorie.

It is yet another object of the present invention to provide a method for improving thirst quenchability and milkiness of acidic milk-based beverages.

### Means For Solving the Problems

According to the present invention, there is provided an acidic milk-based beverage comprising milk, a stabilizer of milk protein, and water, wherein a solid non-fat content of said beverage is 0.15 to 0.4 mass %, and pH of said beverage is not higher than 4.0 (sometimes referred to as the present beverage hereinbelow).

According to the present invention, there is also provided a method for producing the present beverage having a lightness L of 25 to 47 in the Hunter Lab color space, said method comprising the steps of:

providing starting materials comprising milk, a stabilizer of milk protein, and water,

mixing the starting materials, and

adjusting pH of a resulting mixture to not higher than 4.0,

wherein, in said step of providing starting materials, composition of said starting materials is prepared so that a solid non-fat content of a resulting beverage is 0.15 to 0.4 mass o, and so that a lightness L of the resulting beverage in the Hunter Lab color space is 25 to 47.

According to the present invention, there is also provided a method for improving thirst quenchability and milkiness of an acidic milk-based beverage, comprising the steps of:

providing starting materials comprising milk, a stabilizer of milk protein, and water,

mixing the starting materials, and

adjusting pH of a resulting mixture to not higher than 4.0,

wherein, in said step of providing starting materials, composition of said starting materials is prepared so that a solid non-fat content of a resulting beverage is 0.15 to 0.4 mass o, and so that a lightness L of the resulting beverage in the Hunter Lab color space is 25 to 47.

### Effect of the Invention

The present beverage, which adopts the above-mentioned construction, provides good milkiness characteristic of milk-based beverages, while it may be taken like sports drinks and has high thirst quenchability. Further, the beverage obtained by the production method according to the present invention has, in addition to the above effects, the appearance required of the sports drinks and the color tone typical of thirst quencher beverages, and may be provided as a low-calorie acidic milk-based beverage.

### EMBODIMENTS OF THE INVENTION

The present invention will now be explained in detail.

The present beverage contains milk, a stabilizer of milk protein, and water, and has a particular solid non-fat content and a particular pH.

The milk used in the present invention may either be animal or plant origin, for example, animal milk, such as cow's milk, goat's milk, sheep's milk, and horse's milk, and vegetable milk, such as soybean milk. Cow's milk is generally used. One or a mixture of two or more of these kinds of milks may be used. Further, the milk may be fermented with microorganisms, such as lactic acid bacteria or bifidobacteria, and used in the form of a resulting fermented milk.

The form of the milk is not particularly limited, and may be, for example, whole fat milk, skim milk, milk whey, concentrated milk protein, butter milk powder, unsweetened condensed milk, sweetened skimmed condensed milk, or sweetened whole fat condensed milk. Milk reconstituted from powdered milk or concentrated milk may also be used.

The content of the milk in the present beverage is 0.15 to 0.4 mass % in terms of solid non-fat, and the minimum content is preferably 0.2 mass %, more preferably 0.25 mass %, and the maximum content is preferably 0.35 mass %, more preferably 0.3 mass %. At a milk content of less than 0.15 mass % in terms of solid non-fat, the taste and flavor and the milkiness typical of milk-based beverages maybe reduced, whereas at over 0.4 mass %, the color tone is white and turbid, and the thirst quenchability may be reduced.

The stabilizer of milk protein used in the present invention is not particularly limited as long as it is a polysaccharide thickener which may be used in foods and beverages, and soybean polysaccharides are particularly preferred. One or a mixture of two or more polysaccharide thickeners may be used.

The soybean polysaccharides, which are water-soluble polysaccharides obtained from soybeans, are mainly composed of hemicellulose, and further composed of sugars, such as galactose, arabinose, galacturonic acid, rhamnose, xylose, fucose, and glucose. The soybean polysaccharides may be extracted and purified, followed by pasteurization, from okara (fibrous bean curd refuse), which is a by-product of the manufacturing process of soybean oil or separated soy protein from soybeans. The soybean polysaccharides may also be commercial products, such as SM-700 (trade name) , SM-900 (trade name), or SM-1200 (trade name) (all manufactured by San-Ei Gen F.F.I. Inc.).

The content of the stabilizer of milk protein may suitably be decided depending on its kind or the like, as long as the effects of the present invention are not impaired. For example, for proper maintenance of the milk protein stability and good appearance typical of thirst quencher beverages, the minimum content may be usually 0.01 mass %, preferably 0.023 mass %, and the maximum content may be usually 0.1 mass %, preferably 0.080 mass %, particularly preferably 0.069 mass %, with respect to the total amount of the beverage. At higher stabilizer contents, good thirst-quencher-like appearance may not be obtained.

The water used in the present invention is not particularly limited, and may be, for example, ion-exchanged water.

The water content of the present beverage may suitably be selected to be in a desired range, taking into consideration the contents of other components, pH, acidity, and contents of salt or sweeteners as will be discussed later.

The present beverage may optionally contain, in addition to the above-discussed essential components, other components as required, as long as the effects of the present invention and the prescribed properties are not impaired. Such other components may include, for example, salt; monosaccharides, such as fructose or glucose; disaccharides, such as lactose or maltose; high-intensity sweeteners; fruit juice; vegetable juice; vitamins, such as Vitamin C or Vitamin B6; minerals, such as sodium, calcium, or magnesium; souring agents for pH adjustment; dyes, such as marigold or caramel; or flavoring agents.

The present beverage preferably contains salt for enhancing the taste and flavor typical of milk-based beverages and the taste and f lavor typical of thirst quencher beverages. The minimum salt content may preferably be 0.035 mass %, and the maximum salt content may preferably be 0.075 mass %. At a salt content of less than 0.035 mass %, the milkiness and the mildness typical of milk-based beverages may be reduced, whereas at over 0.075 mass %, too strong saltiness may deteriorate the taste and flavor typical of thirst quencher beverages.

The present beverage may preferably contain a high-intensity sweetener for enhancing the sweetness intensity and providing the good taste and flavor typical of acidic milk-based beverages. Examples of the high-intensity sweetener may include Aspartame, acesulfame K, neotame, stevia extract, saccharin, and sucralose, and one or a mixture of two or more of these may be used. It is particularly preferred to use one or a mixture of two or more of Aspartame, acesulfame K, and sucralose.

The content of the high-intensity sweetener that may be present in the present beverage is preferably 0.01 mass %, more preferably 0.02 mass % at a minimum, and preferably 0.04 mass %, more preferably 0.03 mass % at a maximum.

The present beverage usually contains one, two or more of souring agents, fruit juice, and the above-mentioned fermented milk, for adjusting the pH to a predetermined value, or controlling the acidity to a predetermined range.

Examples of the souring agent may include organic acids, such as citric, lactic, acetic, or malic acid, or salts thereof; and inorganic acids, such as phosphoric acid, or salts thereof, with citric and lactic acids being preferred. Too high an acidity may result in strong sourness and may not be suitable for beverages.

Examples of the fruit juice may include juice of citrus, such as orange, lemon, or grapefruit, grape, peach, apple, or banana.

The acidity of the present beverage is an acidity in terms of citric acid (mass %), and may preferably be 0.16 to 0.20 mass %. The acidity in terms of citric acid is determined using a phenolphthalein indicator by titration with sodium hydroxide, and calculated as a citric acid equivalent as follows.

Into a 200 ml conical flask, 5 to 15 g of a sample is precisely measured out, and suitably diluted with water, to which a few drops of a 1% phenolphthalein indicator is added. The resulting mixture is titrated with 0.1 M sodium hydroxide from a 25 ml burette under shaking, and the measurement is terminated when the red color is sustained for 30 seconds. When a hydrogen ion concentration meter is used, the titration is performed in a similar manner under stirring with a magnetic stirrer, and the measurement is terminated at pH 8.1.

The acidity in terms of citric acid is calculated by the following formula:

Acidity in terms of citric acid (mass %)=A×f×100/W×0.0064

A: titrated amount (ml) of 0.1 M sodium hydroxide solution; f: titer of 0.1 M sodium hydroxide solution; W: mass (g) of sample; 0.0064: mass (g) of anhydrous citric acid equivalent to 1 ml of 0.1 M sodium hydroxide solution.

The pH of the present beverage is not higher than 4.0, and the minimum value is preferably 3.0, more preferably 3.25. At over pH 4.0, stability of milk protein over time maybe impaired so that sedimentation may increase, whereas at too low a pH, sourness is strongly felt, which may deteriorate the taste and flavor typical of acidic milk-based beverages.

The L value of the present beverage refers to the lightness, and may be measured with a spectrophotometric colorimeter. A spectrophotometric colorimeter is measuring apparatus which numerically determines color tone and color density of an article. The white turbidity is determined by the intensity of reflected light, and indicated in L value expressing the lightness. Accordingly, a larger L value represents a higher degree of whiteness (white turbidity).

The L value represents color tone measured by a spectrophotometric colorimeter and expressed in the Hunter Lab color space. The L value is preferably 25 to 47, and more preferably 30 at a minimum and more preferably 40 at a maximum.

The a value and the b value in the Hunter Lab color space of the present beverage represents chromaticity expressed as hue and saturation, and may be measured with a spectrophotometric colorimeter, like the L value. A larger a value represents stronger red, and a smaller a value is evaluated as green. A larger b value represents stronger yellow, and a smaller b value is evaluated as blue. The b value of the present beverage is preferably not larger than −7.5 and not smaller than −20.

It is preferred that the kind and content of each component of the present beverage are adjusted to control the energy of the beverage for making the beverage a low calorie beverage. In particular, the energy of the present beverage is controlled to preferably not more than 20 kcal/100 ml, more preferably not more than 5 kcal/100 ml.

In the present beverage, the particle size of the milk protein is preferably not larger than 0.4 μm in median size. Here, the median size is an index generally used for expressing the particle size of a group of particles having a particle size distribution, and refers to a particle size corresponding to the median value of the distribution.

The median size may be measured by means of particle size distribution measuring apparatus, e.g., Model LA-920 manufactured by HORIBA LTD.

The present beverage is preferably provided in the form of an acidic milk-based beverage packaged in a container. The container may be a hermetically-sealed container made of glass; plastics, such as polyethylene terephthalate (PET), polyethylene, or polypropylene; paper; aluminum; or steel. Particularly preferred is a highly transparent container that allows ready confirmation of the desired effects of the present invention and visual observation of the present beverage.

The method for producing an acidic milk-based beverage according to the present invention includes the steps of: providing starting materials comprising milk, a stabilizer of milk protein, and water, mixing the starting materials, and adjusting the pH of the resulting mixture to not higher than 4.0, and may be carried out by, in the step of providing starting materials, preparing the composition of the starting materials so that the solid non-fat content and the L value of the resulting beverage fall within the above-mentioned ranges. Such preparation may be carried out by conventional process of preparing the kinds and the contents of the above-mentioned starting materials.

In the production method of the present invention, homogenization and pasteurization may usually be performed.

The homogenization may be carried out usually in a homogenizer. The conditions of the homogenization are not particularly limited, and preferably at 5 to 25° C. under 10 to 50 Mpa. The homogenization may be carried out before or after the pasteurization, or both.

The pasteurization may be carried out, for example, by pasteurization under heating of a sterilization value equivalent to or higher than pasteurization at 65° C. for 10 minutes. The method of the pasteurization is not particularly limited, and ordinary methods, such as plate pasteurization, tubular pasteurization, retort pasteurization, batch pasteurization, or autoclaving, may be employed. The pasteurization may be carried out before or after the homogenization, or both, or before or after packaging in a container, or both.

The pasteurized present beverage may be provided as a packaged acidic milk-based beverage, for example, by packaging the beverage in a container by hot-filling, and cooling the filled container; or by cooling the beverage to the temperature suitable for filling a container, and packaging the cooled beverage in a previously washed and sterilized container by aseptic filling.

The method for improving thirst quenchability and milkiness of an acidic milk-based beverage according to the present invention includes the steps of: providing starting materials comprising milk, a stabilizer of milk protein, and water, mixing the starting materials, and adjusting pH of a resulting mixture to not higher than 4.0, and characterized in that, in the step of providing starting materials, the composition of the starting materials is prepared so that the solid non-fat content and the L value of the resulting beverage fall within the above-mentioned ranges.

The method for improving thirst quenchability and milkiness of an acidic milk-based beverage may be carried out, for example, by the method discussed above with regard to the production method according to the present invention.

### EXAMPLES

The present invention will now be explained in more detail with reference to Examples, Comparative Examples, and Referential Examples, but the present invention is not limited thereto.

In the following, as soybean polysaccharides, SM-1200 (trade name, manufactured by San-Ei Gen F.F.I. Inc.) was used. The homogenization was carried out in a laboratory homogenizer (Model 15MR, manufactured by APV Gaulin Inc.) at 20° C. under 15 MPa. The pasteurization under heating was carried out by pasteurization at 95° C. The L, a, and b values were determined by means of a spectrophotometric colorimeter (CM-3500d, manufactured by KONICA MINOLTA, INC.) under the following conditions; color space: Hunter Lab, light source: D65, measured view: 10°.

### Example 1

To 63 g of 25 mass % reconstituted skim milk (referred to merely as the skim milk hereinbelow), 133 g of a 3 mass % aqueous solution of soybean polysaccharides (referred to as the soybean polysaccharides aqueous solution hereinbelow) was added and stirred into a homogeneous mixture. Then 178 g of a 10 mass % aqueous solution of citric acid was added and thoroughly stirred. Next, 58 g of a 10 mass % aqueous solution of salt, 90 g of a 1 mass % aqueous solution of Aspartame, 90 g of a 1 mass % aqueous solution of acesulfame K, and 45 g of a 1 mass % aqueous solution of sucralose were added in series and stirred, to which 25 g of a flavoring agent was added. The resulting mixture was diluted to 9.5 kg with ion exchanged water, and the pH was adjusted to 3.75 with 114 g of a 10 mass % aqueous solution of trisodium citrate (referred to as the trisodium citrate aqueous solution hereinbelow). Then the resulting mixture was diluted to 10 kg with ion exchanged water and homogenized, to thereby prepare a preparation. The preparation thus obtained was pasteurized under heating to obtain an acidic milk-based beverage. This acidic milk-based beverage was packaged in a container by hot-filling and cooled with water down to the room temperature.

The obtained acidic milk-based beverage was evaluated as will be described below. The results are shown in Table 1. As the properties of the obtained acidic milk-based beverage, solid non-fat (SNF) content, acidity in terms of citric acid, sweetener content in the beverage, salt content in the beverage, pH, energy (calories), and L, a, and b values are also shown in Table 1.

### <Evaluation Procedure>

(1) Evaluation of Beverage Texture

Sensory assessments were made by six proficient panels, and the outcomes were expressed numerically according to the following standard, and the average was taken as the result.

### <Thirst Quenchability>

8 points: quenching

6 points: slightly quenching

4 points: neutral

2 points: slightly unquenching

0 point: unquenching

### <Gulpability>

8 points: gulpable

6 points: slightly gulpable

4 points: neutral

2 points: slightly ungulpable

0 point: ungulpable

### <Mildness>

8 points: mild

6 points: slightly mild

4 points: neutral

2 points: slightly not mild

0 point: not mild

### <Milkiness>

8 points: milky

6 points: slightly milky

4 points: neutral

2 points: slightly not milky

0 point: not milky

### <Overall Taste and Flavor>

8 points: good

6 points: slightly good

4 points: neutral

2 points: slightly bad

0 point: bad

(2) Evaluation of Beverage Appearance

Sensory assessments were made by six proficient panels, and the outcomes were expressed numerically according to the following standard, and the average was taken as the result.

### <Typicalness of Thirst Quencher Beverage>

“Typicalness of thirst quencher beverage” means the appearance of beverages that appear to be “thirst quenching” and “gulpable”.

8 points: typical

6 points: slightly typical

4 points: neutral

2 points: slightly untypical

0 point: untypical

### <Typicalness of Milk-Based Beverage>

“Typicalness of milk-based beverage” means the appearance of beverages that appear to be “mild” and “milky”.

8 points: typical

6 points: slightly typical

4 points: neutral

2 points: slightly untypical

0 point: untypical

### Examples 2 to 6 and Comparative Examples 1 to 3

An acidic milk-based beverage was prepared in the same way as in Example 1, except that the amount of the skim milk was changed so that the SNF content was as shown in Table 1. The obtained acidic milk-based beverage was measured for the properties and evaluated in the same way as in Example 1. The results are shown in Table 1.

TABLE 1

| | | Comparative | Comparative | Example | Example | Example | Example | Example | Example | Comparative |
|---|---|---|---|---|---|---|---|---|---|---|
| | | Example 1 | Example 2 | 1 | 2 | 3 | 4 | 5 | 6 | Example 3 |
| Property | SNF (mass %) | 0.05 | 0.10 | 0.15 | 0.20 | 0.25 | 0.30 | 0.35 | 0.40 | 0.50 |
| | Acidity in terms | 0.18 | 0.18 | 0.18 | 0.18 | 0.18 | 0.18 | 0.18 | 0.18 | 0.18 |
| | of citric acid | | | | | | | | | |
| | (w/w %) | | | | | | | | | |
| | Sweetener (mass %) | 0.0275 | 0.0275 | 0.0275 | 0.0275 | 0.0275 | 0.0275 | 0.0275 | 0.0275 | 0.0275 |
| | Salt (mass %) | 0.058 | 0.058 | 0.058 | 0.058 | 0.058 | 0.058 | 0.058 | 0.058 | 0.058 |
| | pH | 3.75 | 3.75 | 3.75 | 3.75 | 3.75 | 3.75 | 3.75 | 3.75 | 3.75 |
| | Energy (kcal) | 2 | 2 | 2 | 3 | 3 | 3 | 3 | 3 | 4 |
| Sensory | Thirst | 7.7 | 7.5 | 7.0 | 6.3 | — | 5.7 | 4.7 | 4.0 | 3.3 |
| assessment | quenchability | | | | | | | | | |
| | Gulpability | 7.7 | 7.3 | 7.0 | 6.3 | — | 5.7 | 4.7 | 4.0 | 3.5 |
| | Mildness | 2.7 | 3.7 | 4.3 | 5.2 | — | 5.7 | 6.2 | 6.3 | 7.2 |
| | Milkiness | 2.7 | 3.7 | 4.3 | 5.3 | — | 5.7 | 6.2 | 6.5 | 7.2 |
| | Overall taste | 5.7 | 6.7 | 6.7 | 7.0 | — | 7.0 | 6.2 | 5.8 | 5.5 |
| | and flavor | | | | | | | | | |
| Color | L value | 18.2 | 22.2 | 25.8 | 32.5 | 42.4 | 46.7 | 50.6 | 54.4 | 59.9 |
| tone | a value | −0.6 | −0.7 | −0.9 | −1.5 | −2.0 | −2.5 | −2.7 | −2.9 | −3.1 |
| | b value | −5.7 | −7.7 | −9.5 | −11.6 | −10.2 | −11.2 | −10.6 | −9.8 | −8.1 |
| Appearance | Typicalness of | 8.0 | 7.8 | 7.2 | 6.2 | 4.7 | 4.2 | 3.3 | 2.7 | 2.3 |
| | thirst quencher | | | | | | | | | |
| | beverage | | | | | | | | | |
| | Typicalness of | 2.7 | 3.3 | 4.2 | 5.3 | 6.5 | 6.8 | 7.7 | 7.8 | 7.8 |
| | milk-based | | | | | | | | | |
| | beverages | | | | | | | | | |

### Examples 7 to 9

An acidic milk-based beverage was prepared in the same way as in Example 1, except that the amount of the trisodium citrate aqueous solution was changed so that the pH was as shown in Table 2. As the properties of the obtained acidic milk-based beverage, SNF, acidity in terms of citric acid, sweetener content in the beverage, salt content in the beverage, pH, energy (calories), and color tone are shown in Table 2. Incidentally, Example 3 in Table 2 is an acidic milk-based beverage prepared in the same way as in Example 3 above, and measured newly for the color tone. Thus, the results of the measurements of color tone of Example 3 are slightly different between Tables 1 and 2.

TABLE 2

| | | Example 7 | Example 8 | Example 3 | Example 9 |
|---|---|---|---|---|---|
| Property | SNF | 0.25 | 0.25 | 0.25 | 0.25 |
| | (mass %) | | | | |
| | Acidity in | 0.18 | 0.18 | 0.18 | 0.18 |
| | terms of | | | | |
| | citric acid | | | | |
| | (w/w %) | | | | |
| | Sweetener | 0.0275 | 0.0275 | 0.0275 | 0.0275 |
| | (mass %) | | | | |
| | Salt | 0.058 | 0.058 | 0.058 | 0.058 |
| | (mass %) | | | | |
| | pH | 3.25 | 3.50 | 3.75 | 4.00 |
| | Energy | 3 | 3 | 3 | 3 |
| | (kcal) | | | | |
| Color | L value | 31.2 | 37.1 | 41.4 | 44.0 |
| tone | a value | −1.5 | −1.8 | −2.1 | −2.2 |
| | b value | −9.3 | −10.1 | −9.8 | −9.1 |

The results in Table 1 show that at a SNF content of 0.1 mass % or lower, the evaluation of “mildness” and “milkiness” was poor, whereas at a SNF content of 0.5 mass % or higher, the evaluation of “thirst quenchability” and “gulpability” was poor. Thus, it was demonstrated that, with the SNF content in the range of 0.15 to 0.4 mass %, milk-based beverages were obtained having both the taste and flavor typical of thirst quencher beverages and the taste and flavor typical of milk-based beverages and excellent in overall taste and flavor.

It was also demonstrated that, with the L value of the beverage in the range of 25 to 47, milk-based beverages were obtained having both the appearance typical of thirst quencher beverages and the appearance typical of milk-based beverages. Incidentally, the SNF content corresponding to the above-mentioned range was within the range of 0.15 to 0.3 mass %. Further, the L values determined at different pH levels are shown in Table 2, which shows that at pH 4.0 or lower, both “typicalness of milk-based beverage” and “typicalness of thirst quencher beverage” were appreciated.

Incidentally, Example 3 in Table 2 is an acidic milk-based beverage prepared in the same way as in Example 3 above, and measured newly for the color tone in the same way as in Example 1. Thus, the results of the measurements of color tone of Example 3 are slightly different between Tables 1 and 2.

### Examples 10 to 12

An acidic milk-based beverage was prepared in the same way as in Example 1, except that the amount of the soybean polysaccharides aqueous solution was changed as shown in Table 3. As the properties of the obtained acidic milk-based beverage, SNF, acidity in terms of citric acid, sweetener content in the beverage, salt content in the beverage, pH, and energy are shown in Table 3. Further, the sensory assessments and the measurements of color tone were made in the same way as in Example 1, and the median size was measured with Model LA-920 (manufactured by HORIBA, LTD.). The results are shown in Table 3.

TABLE 3

| | | Example | Example | Example |
|---|---|---|---|---|
| | | 10 | 11 | 12 |
| Property | SNF | 0.25 | 0.25 | 0.25 |
| | Acidity in terms of | 0.18 | 0.18 | 0.18 |
| | citric acid (w/w %) | | | |
| | High-intensity | 0.0225 | 0.0225 | 0.0225 |
| | sweetener (mass %) | | | |
| | Salt (mass %) | 0.058 | 0.058 | 0.058 |
| | Soybean | 0.005 | 0.08 | 0.2 |
| | polysaccharides | | | |
| | (mass %) | | | |
| | pH | 3.75 | 3.75 | 3.75 |
| | Energy (kcal) | 3 | 3 | 3 |
| Sensory | Thirst quenchability | 5.5 | 5.9 | 4.5 |
| assessment | Gulpability | 5.3 | 5.6 | 4.7 |
| | Mildness | 5.5 | 5.9 | 6.5 |
| | Milkiness | 5.7 | 5.8 | 6.1 |
| | Overall taste and | 5.9 | 6.3 | 5.6 |
| | flavvor | | | |
| Color | L value | 43.27 | 40.51 | 41.3 |
| tone | a value | −1.54 | −1.61 | −1.57 |
| | b value | −6.11 | −8.01 | −7.25 |
| Appearance | Typicalness of thirst | 3.6 | 4.2 | 2.4 |
| | quencher beverages | | | |
| | Typicalness of | 6.5 | 5.3 | 5.9 |
| | milk-based beverages | | | |
| Particle | Median size (μm) | 0.47 | 0.16 | 0.27 |
| size | | | | |

The results in Table 3 show that acidic milk-based beverages were obtained having both the taste and flavor typical of thirst quencher beverages and the taste and flavor typical of milk-based beverages assessed in the sensory assessment and excellent in overall taste and flavor, irrespective of the soybean polysaccharides contents therein.

On the other hand, it is seen that, in Example 10 with a low soybean polysaccharides content, the results of the sensory assessments were good, but the median size of the milk protein contained in the beverage was large. The acidic milk-based beverage of Example 10 having such a median size is assumed to exhibit inferior stability, compared to those of the other Examples. It is further seen that, in Example 12 with a high soybean polysaccharides content, the results of the sensory assessments were good, but the appearance typical of thirst quencher beverages was impaired due to the influence of the high soybean polysaccharides content on the appearance, and the high color tone b value.

1. An acidic milk-based beverage comprising milk, a stabilizer of milk protein, and water, wherein a solid non-fat content of said beverage is 0.15 to 0.4 mass %, and pH of said beverage is not higher than 4.0.

2. The acidic milk-based beverage according to claim 1, wherein said beverage has a lightness L of 25 to 47 in the Hunter Lab color space.

3. The acidic milk-based beverage according to claim 1, further comprising salt.

4. The acidic milk-based beverage according to claim 1, wherein a content of said stabilizer of milk protein is not less than 0.01 mass % and not more than 0.1 mass %.

5. The acidic milk-based beverage according to claim 1, wherein said stabilizer of milk protein is soybean polysaccharides.

6. The acidic milk-based beverage according to claim 1, wherein acidity in terms of citric acid of said beverage is 0.16 to 0.20 mass %.

7. The acidic milk-based beverage according to claim 1, further comprising a high-intensity sweetener at 0.01 to 0.04 mass %.

8. The acidic milk-based beverage according to claim 1, wherein energy of said beverage is not higher than 20 kcal/100 ml.

9. A method for producing the acidic milk-based beverage of claim 2, said method comprising the steps of:
providing starting materials comprising milk, a stabilizer of milk protein, and water,
mixing the starting materials, and
adjusting pH of a resulting mixture to not higher than 4.0,
wherein, in said step of providing starting materials, composition of said starting materials is prepared so that a solid non-fat content of a resulting beverage is 0.15 to 0.4 mass %, and so that a lightness L of the resulting beverage in the Hunter Lab color space is 25 to 47.

10. A method for improving thirst quenchability and milkiness of an acidic milk-based beverage, comprising the steps of:
providing starting materials comprising milk, a stabilizer of milk protein, and water,
mixing the starting materials, and
adjusting pH of a resulting mixture to not higher than 4.0,
wherein, in said step of providing starting materials, composition of said starting materials is prepared so that a solid non-fat content of a resulting beverage is 0.15 to 0.4 mass %, and so that a lightness L of the resulting beverage in the Hunter Lab color space is 25 to 47.
